(19) United States
(12) Patent Application Publication
(10) Pub. No.: US 2023/0325536 A1
(43) Pub. Date: Oct. 12, 2023

(54) POWER SUPPLY UNIT AUTHENTICATION

(71) Applicant: Intel Corporation, Santa Clara, CA (US)

(72) Inventors: Vijai KRISHNAMURTHY, Bangalore (IN); Santosh Kumar SAHU, Banaglore (IN)

(73) Assignee: Intel Corporation, Santa Clara, CA (US)

(21) Appl. No.: 18/209,180

(22) Filed: Jun. 13, 2023

(51) Int. Cl. G06F 21/73; G06F 21/50

(52) U.S. Cl. CPC G06F 21/73; G06F 21/50

(57) ABSTRACT

Examples described herein relate to during a boot of a power supply unit (PSU) connected to a computer platform, circuitry to receive a firmware identifier and manufacturer identifier associated with the PSU and determine whether the PSU is approved to utilize. In some examples, based on, at least, authentication of the firmware identifier and manufacturer identifier of the PSU, the circuitry is to permit access to data and/or power from the PSU. In some examples, based on, at least, failure to authenticate the firmware identifier or manufacturer identifier of the PSU, the circuitry is to deny access to data and/or power from the PSU.

### BACKGROUND

In a server platform, sideband management activities can occur during sleep (Sx) power state or while transitioning the platform from sleep state to standby (S0) state. For example, management activities can include a Baseboard Management Controller (BMC) acquiring operational state from a power supply unit (PSU), determining power budget capacity, and accessing other platform data. For example, platforms can transmit power management bus commands (e.g., input voltage (READ_VIN), output voltage (READ_VOUT), output current (READ_IOUT), sensor operating temperature (READ_TEMPERATURE) to PSUs to obtain data such as rated power capacity, operational voltage (e.g., 220 volts/110 volts (e.g., High Line/Low Line)). The platform can utilize data from the PSU for computing power budget for platform sub-systems (e.g., central processing unit (CPU), memory, graphics processing unit (GPU), and others).

### BRIEF DESCRIPTION OF THE DRAWINGS

FIG. 1 depicts an example system.

FIG. 2 depicts an example process.

FIG. 3 depicts an example process.

FIG. 4 depicts an example system.

### DETAILED DESCRIPTION

On a server platform, a PSU can be one of the first devices to boot. After booting, power from the PSU can be utilized to turn-on or power-up other devices. However, where a PSU has not been accounted for in a chain of trust, a potential security vulnerability can arise where an untrusted vendor's PSU can be connected to the platform and can subsequently cause harm to the platform with actions that impair operation of the server platform. When a BMC firmware (BMC FW) collects power measurement data from a PSU at run-time and the platform allows an in-field PSU firmware update (e.g., triggered by a configuration from administrator), such power management data can be accessed and potentially tampered with to cause a server to malfunction. Plundervolt is a method of hacking that involves depriving server power by undervolting or reducing power output so that processing errors occur. These errors can expose sensitive data and weaken server chip security components.

At least to attempt to reduce a risk of a PSU or PSU firmware from an unauthorized source being utilized, a PSU can be allocated to a security chain of trust. A platform management firmware can generate a unique secure firmware identifier (ID) for a specific PSU firmware and bind the firmware ID to one or more PSU device identifiers. For example, a PSU's hardware identification (PPID) and firmware ID can be checked to determine if the PSU hardware and PSU firmware are trusted and can be utilized. Prior to calculation of power budget, management firmware can read the PSU hardware identification (PPID) and the firmware ID and authenticate and verify if the installed PSU and PSU firmware is compatible with the platform or not. If PSU authentication is successful, a platform can be brought from reduced power usage state (e.g., Sx/M3 or Sx/M0) to a higher power usage state (e.g., S0/M0). If PSU authentication is not successful, the platform can remain in reduced power usage state, such as S5SU. Accordingly, platform power budget and platform system level power monitoring can be brought into a trust zone and power data from a PSU can be trusted if the PSU device identifier and PSU firmware identifier are approved.

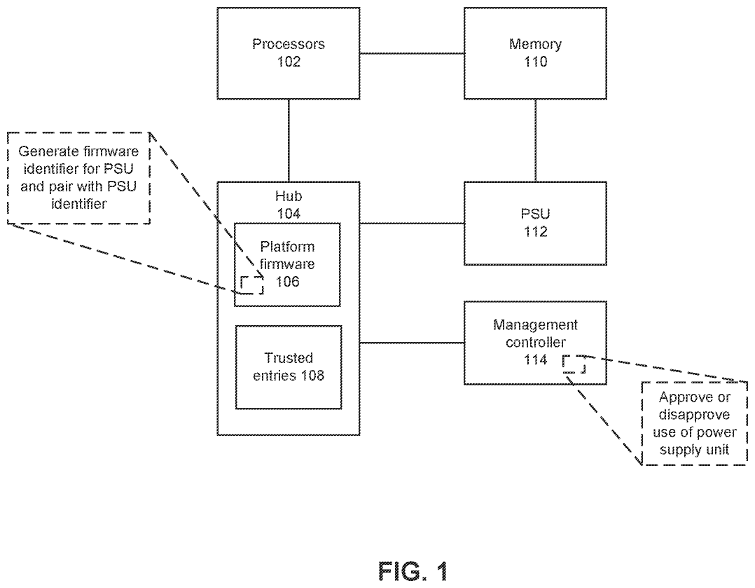

FIG. 1 depicts an example system. Processor 102 can include one or more processor cores configured to process a specific instruction set. In some examples, instruction set may facilitate Complex Instruction Set Computing (CISC), Reduced Instruction Set Computing (RISC), or computing via a Very Long Instruction Word (VLIW). Processors 100 may process different instruction sets, which may include instructions to facilitate the emulation of other instruction sets. Processors 100 may also include other processing devices, such as a Digital Signal Processor (DSP). Processors 100 can be part of a central processing unit (CPU) or graphics processing unit (GPU).

Memory 110 can include one or more of: one or more registers, one or more cache devices (e.g., level 1 cache (L1), level 2 cache (L2), level 3 cache (L3), last level cache (LLC)), volatile memory device, non-volatile memory device, or persistent memory.

PSU 112 can output power to platform hub 104 and/or other devices. PSU 112 can generate power data such as rated power capacity, output power level, average output power level over a time period, current level, average current level over a time period, line voltage, average line voltage over a time period, platform temperature, average platform temperature over a time period, or others. PSU 112 can be connected to hub 104 using power management bus, or other interface (e.g., I2C or I3C).

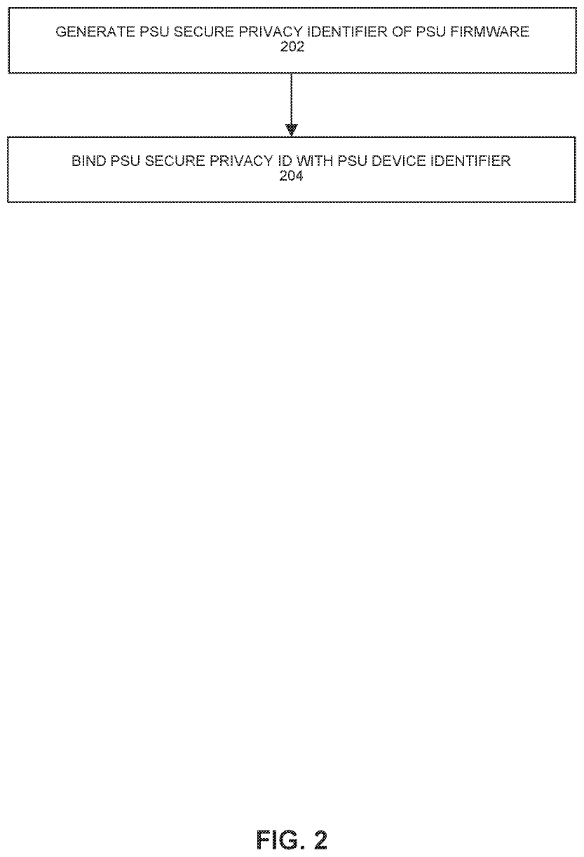

Platform hub 104 can provide communications to various devices and circuitry such as processors 102, platform hub 104, memory 110, PSU 112, management controller 114, and others. Platform hub 104 can include various interfaces such as a display interface, memory controller, input/output controller, and clock signal interface. Platform management firmware 106 can execute on hub 104 to generate a firmware identifier for PSU 112 and pair the firmware identifier with a device identifier of PSU 112. An example operation of platform management firmware 106 is described with respect to FIG. 2.

Management controller 114 can perform various management operations for a platform such as management and monitoring capabilities for system administrators to monitor operation of system using out-of-band channels. Management controller 114 can execute firmware or include circuitry that is to verify whether a pair of firmware identifier and device identifier associated with PSU 112 are approved for use based on access to trusted entries 108. Trusted entries 108 can store permitted PSU device identifiers, permitted PSU firmware identifiers, and other entries. At or after boot of hub 104, management controller 114 can access device and firmware identifiers of PSU 112. In some examples, PSU 112 can encode transmissions of firmware identifier and device identifier from PSU 112 to hub 104 using a Cyclic Redundancy Check (CRC) value, checksum, or encryption to uniquely identify a sender PSU and potentially protect against spoofing attempts where a PSU provides secure privacy identifier and device identifier of PSU of another PSU. As described herein, based on a firmware identifier and device identifier of PSU matching trusted entries 108 identifying a permitted PSU, management controller 114 can permit utilization of PSU 112 to supply power and authorize access to data from PSU 112. Based on secure privacy identifier or device identifier of PSU not matching trusted entries of permitted PSU, management controller 114 may not allow hub 104 and associated server or host system to enter a higher power state and can deny use of PSU 112. Platform management firmware 106 can generate a log in case malfunction occurs involving PSU 112 to indicate the PSU 112 did not have valid credentials. Management controller 114 can be connected to hub 104 using power management bus or other interface (e.g., I2C or I3C). Management controller 114 can be implemented as one or more of: Board Management Controller (BMC), Intel® Management or Manageability Engine (ME), or other devices.

FIG. 2 depicts an example process. The process can be performed by a firmware or other circuitry associated with a platform hub. At 202, platform management firmware executing on a platform hub or a management controller or an orchestrator can generate a secure privacy ID for a specific firmware executed by the PSU and bind the secure privacy ID with a set of one or more PSUs. The secure privacy ID can be generated by a hash of PSU firmware binary image and can be stored as an encrypted or unencrypted format in a register or memory on the PSU. A platform provisioning ID (PPID) given by a manufacturer of the PSU can be stored in an encrypted or unencrypted format in a fuse or read only memory (ROM) of the PSU by a manufacturer of the PSU. At 204, the platform management firmware can bind and pair the secure privacy ID with the PPID so that the secure privacy ID and PPID are presented as a pair to management controller for authentication.

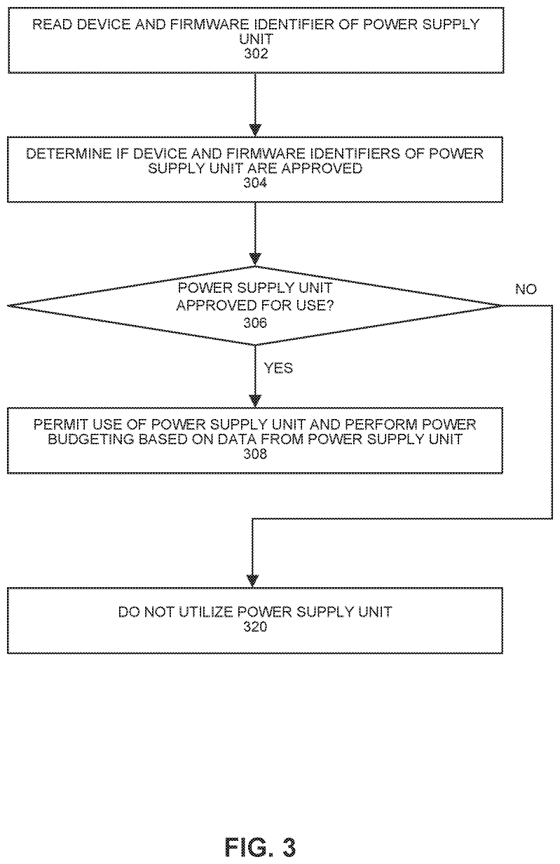

FIG. 3 depicts an example process. The process can be performed by a management controller or platform. At 302, prior to calculating a power budget for a platform and connected devices, management firmware, software, or circuitry can read a pair of PSU hardware identifier (PPID) value and firmware secure privacy ID value from the PSU. At 304, a determination can be made if the PSU is compatible with the platform or not. For example, a determination can be made if the pair of PPID value and firmware secure privacy ID value match an approved pair of PPID value and firmware secure privacy ID value in a database accessible to a platform. For example, the platform can transmit using an encrypted channel, the pair of PPID value and firmware secure privacy ID value to an orchestrator server to determine if the pair of PPID value and firmware secure privacy ID value are approved or access an encrypted database from memory. To access the pair of PPID value and firmware secure privacy ID value, power management bus sensors can be read as well as PSU address, bus identifier, or others.

At 306, a determination can be made if the PSU is approved for use. For example, the PSU can be approved for use if the pair of PPID value and firmware secure privacy ID value match a pair of an approved pair of PPID value and firmware secure privacy ID value. Note that a PSU device identifier can be paired with one or more firmware secure privacy ID values so that the PSU can utilize different approved firmware versions. Note that a firmware secure privacy ID value can be paired with one or more PSU device identifier values so that a firmware can be utilized by different approved PSU devices.

If the PSU is approved for use, at 308, the platform can utilize the power supply and the platform can be brought from lower power state (e.g., sleeping, standby, soft off, mechanical off, Sx/M3, or Sx/M0) to higher power usage state (e.g., working power or S0/M0). For example, Advanced Configuration and Power Interface (ACPI) specification from 1996 and later can define various platform power states. Power supply based power budgeting can be performed using PSU data from the PSU. PSU data can include one or more of: rated power capacity, output power level, average output power level over a time period, current level, average current level over a time period, line voltage, average line voltage over a time period, platform temperature, average platform temperature over a time period, or others. Power budgeting based on PSU data can be performed such as allocating instantaneous power, peak power, or average power to different connected components.

At 320, based on non-approval of use of the PSU, the PSU may not be utilized. In addition, data from the PSU may not be accessed. The platform can search for another PSU to determine if another PSU is approved for use, such as a datacenter power distribution unit (PDU) and the process can repeat at 302 for the another PSU.

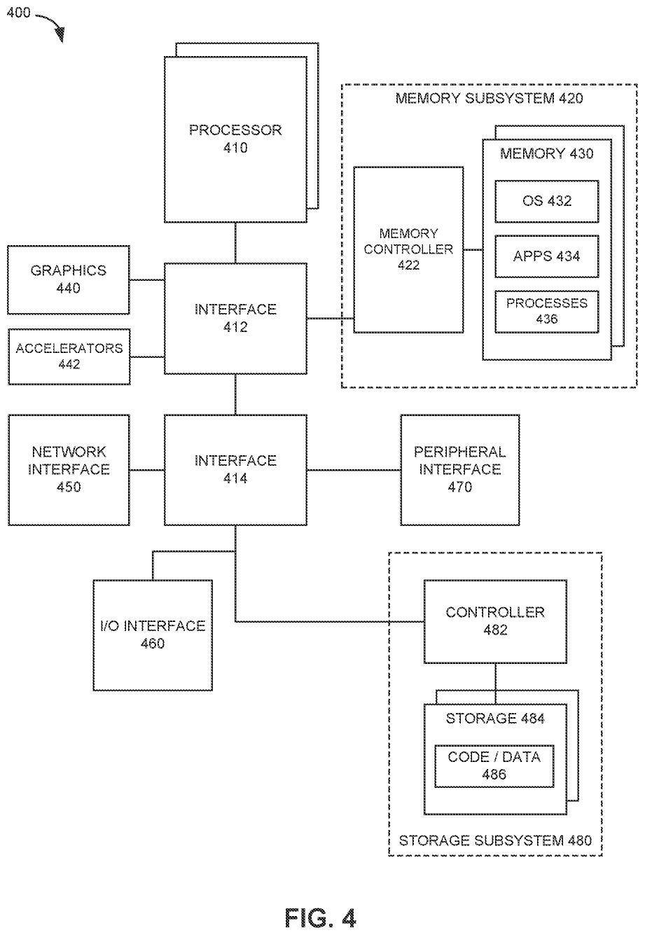

FIG. 4 depicts a system. System 400 includes processors 410, which provides processing, operation management, and execution of instructions for system 400. Processors 410 can include any type of microprocessor, central processing unit (CPU), graphics processing unit (GPU), XPU, processing core, or other processing hardware to provide processing for system 400, or a combination of processors. An XPU can include one or more of: a CPU, a graphics processing unit (GPU), general purpose GPU (GPGPU), and/or other processing units (e.g., accelerators or programmable or fixed function FPGAs). Processors 410 controls the overall operation of system 400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processors 410 can include one or more processor sockets.

In some examples, interface 412 and/or interface 414 can include a switch (e.g., CXL switch) that provides device interfaces between processors 410 and other devices (e.g., memory subsystem 420, graphics 440, accelerators 442, network interface 450, and so forth). In some examples, interface 412 and/or interface 414 can include a platform and/or be connected to management controller to approve or deny use of a power supply unit, as described herein.

In one example, system 400 includes interface 412 coupled to processors 410, which can represent a higher speed interface or a high throughput interface for system components that needs higher bandwidth connections, such as memory subsystem 420 or graphics interface components 440, or accelerators 442. Interface 412 represents an interface circuit, which can be a standalone component or integrated onto a processor die.

Accelerators 442 can be a programmable or fixed function offload engine that can be accessed or used by a processors 410. For example, an accelerator among accelerators 442 can provide compression (DC) capability, cryptography services such as public key encryption (PKE), cipher, hash/authentication capabilities, decryption, or other capabilities or services. In some cases, accelerators 442 can be integrated into a CPU socket (e.g., a connector to a motherboard or circuit board that includes a CPU and provides an electrical interface with the CPU). For example, accelerators 442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 442 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 420 represents the main memory of system 400 and provides storage for code to be executed by processors 410, or data values to be used in executing a routine. Memory subsystem 420 can include one or more memory devices 430 such as read-only memory (ROM), flash memory, one or more varieties of random access memory (RAM) such as DRAM, or other memory devices, or a combination of such devices. Memory 430 stores and hosts, among other things, operating system (OS) 432 to provide a software platform for execution of instructions in system 400. Additionally, applications 434 can execute on the software platform of OS 432 from memory 430. Applications 434 represent programs that have their own operational logic to perform execution of one or more functions. Applications 434 and/or processes 436 can refer instead or additionally to a virtual machine (VM), container, microservice, processor, or other software. Processes 436 represent agents or routines that provide auxiliary functions to OS 432 or one or more applications 434 or a combination. In some examples, applications 434 and/or processes 436 can refer to a service mesh interface.

OS 432, applications 434, and processes 436 provide software logic to provide functions for system 400. In one example, memory subsystem 420 includes memory controller 422, which is a memory controller to generate and issue commands to memory 430. It will be understood that memory controller 422 could be a physical part of processors 410 or a physical part of interface 412. For example, memory controller 422 can be an integrated memory controller, integrated onto a circuit with processors 410.

In some examples, OS 432 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on one or more processors sold or designed by Intel®, ARM®, AMD®, Qualcomm®, IBM®, Nvidia®, Broadcom®, Texas Instruments®, among others.

While not specifically illustrated, it will be understood that system 400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 400 includes interface 414, which can be coupled to interface 412. In one example, interface 414 represents an interface circuit, which can include standalone components and integrated circuitry. In one example, multiple user interface components or peripheral components, or both, couple to interface 414. Network interface 450 provides system 400 the ability to communicate with remote devices (e.g., servers or other computing devices) over one or more networks. Network interface 450 can include an Ethernet adapter, wireless interconnection components, cellular network interconnection components, USB (universal serial bus), or other wired or wireless standards-based or proprietary interfaces. Network interface 450 can transmit data to a device that is in the same data center or rack or a remote device, which can include sending data stored in memory. Network interface 450 can receive data from a remote device, which can include storing received data into memory.

In some examples, network interface 450 can be implemented as a network interface controller, network interface card, a host fabric interface (HFI), or host bus adapter (HBA), and such examples can be interchangeable. Network interface 450 can be coupled to one or more servers using a bus, PCIe, CXL, or DDR. Network interface 450 may be embodied as part of a system-on-a-chip (SoC) that includes one or more processors, or included on a multichip package that also contains one or more processors.

Some examples of network device 450 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network device 450 can include a programmable processing pipeline or offload circuitries that is programmable by P4, Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be used utilized for packet processing or packet modification. Ternary content-addressable memory (TCAM) can be used for parallel match-action or look-up operations on packet header content.

In one example, system 400 includes one or more input/output (I/O) interface(s) 460. I/O interface 460 can include one or more interface components through which a user interacts with system 400 (e.g., audio, alphanumeric, tactile/touch, or other interfacing). Peripheral interface 470 can include any hardware interface not specifically mentioned above. Peripherals refer generally to devices that connect dependently to system 400. A dependent connection is one where system 400 provides the software platform or hardware platform or both on which operation executes, and with which a user interacts.

In one example, system 400 includes storage subsystem 480 to store data in a nonvolatile manner. In one example, in certain system implementations, at least certain components of storage 480 can overlap with components of memory subsystem 420. Storage subsystem 480 includes storage device(s) 484, which can be or include any conventional medium for storing large amounts of data in a nonvolatile manner, such as one or more magnetic, solid state, or optical based disks, or a combination. Storage 484 holds code or instructions and data 486 in a persistent state (e.g., the value is retained despite interruption of power to system 400). Storage 484 can be generically considered to be a “memory,” although memory 430 is typically the executing or operating memory to provide instructions to processors 410. Whereas storage 484 is nonvolatile, memory 430 can include volatile memory (e.g., the value or state of the data is indeterminate if power is interrupted to system 400). In one example, storage subsystem 480 includes controller 482 to interface with storage 484. In one example controller 482 is a physical part of interface 414 or processors 410 or can include circuits or logic in processors 410 and interface 414.

In an example, system 400 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as Non-volatile Memory Express (NVMe) over Fabrics (NVMe-oF) or NVMe.

In some examples, system 400 can be implemented using interconnected compute nodes of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

What is claimed is:

1. An apparatus comprising:
circuitry to, during a boot of a power supply unit (PSU) connected to a computer platform, receive a firmware identifier and manufacturer identifier associated with the PSU and determine whether the PSU is approved to utilize, wherein:
based on, at least, authentication of the firmware identifier and manufacturer identifier of the PSU, the circuitry is to permit access to data and/or power from the PSU and
based on, at least, failure to authenticate the firmware identifier or manufacturer identifier of the PSU, the circuitry is to deny access to data and/or power from the PSU.

2. The apparatus of claim 1, wherein the data comprises one or more of: rated power capacity, average output power level over a time period, current level, average current level over a time period, line voltage, average line voltage over a time period, platform temperature, or average platform temperature over a time period.

3. The apparatus of claim 1, wherein the computer platform is coupled to at least one processor, a management controller, and the PSU.

4. The apparatus of claim 1, wherein the determine whether the PSU is approved to utilize is based on access to an encrypted database of approved firmware and device identifiers.

5. The apparatus of claim 1, comprising the computer platform and wherein the computer platform comprises the circuitry.

6. The apparatus of claim 1, wherein the PSU comprises a power distribution unit for multiple platforms.

7. The apparatus of claim 1, comprising a server, wherein the server comprises the circuitry.

8. A method comprising:
generating a firmware identifier of firmware executed by a power supply unit (PSU);
pairing the firmware identifier with a manufacturer identifier of the PSU;
permitting usage of the PSU based on the firmware identifier and the manufacturer identifier matching an approved entry; and
denying usage of the PSU based on either the firmware identifier or the manufacturer identifier not matching an approved entry.

9. The method of claim 8, wherein the permitting usage of the PSU comprises permitting access to data and/or power from the PSU.

10. The method of claim 8, wherein the denying usage of the PSU comprises
denying access to data and/or power from the PSU.

11. The method of claim 8, wherein the denying usage of the PSU comprises
causing a platform to remain in a reduced power usage state.

12. The method of claim 8, wherein the usage of the PSU comprises access to data comprising one or more of: average output power level over a time period, current level, average current level over a time period, line voltage, average line voltage over a time period, platform temperature, or average platform temperature over a time period.

13. The method of claim 8, wherein a management controller performs the generating a firmware identifier of firmware executed by the PSU.

14. At least one non-transitory computer-readable medium comprising instructions stored thereon, that if executed by one or more processors, cause the one or more processors to:
generate a firmware identifier of firmware executed by a power supply unit (PSU);
pair the firmware identifier with a manufacturer identifier of the PSU;
permit usage of the PSU based on the firmware identifier and the manufacturer identifier matching an approved entry; and
deny usage of the PSU based on either the firmware identifier or the manufacturer identifier not matching an approved entry.

15. The non-transitory computer-readable medium of claim 14, wherein the permit usage of the PSU comprises permitting access to data and/or power from the PSU.

16. The non-transitory computer-readable medium of claim 14, wherein the deny usage of the PSU comprises deny access to data and/or power from the PSU.
